(19) United States
(12) Patent Application Publication
(10) Pub. No.: US 2023/0364934 A1
(43) Pub. Date: Nov. 16, 2023

(54) SMART BANKNOTES

(71) Applicant: Leandro Antônio Gonçalves GIORDANO, Brasília (BR)

(72) Inventor: Leandro Antônio Gonçalves GIORDANO, Brasília (BR)

(21) Appl. No.: 18/359,121

(22) Filed: Jul. 26, 2023

Related U.S. Application Data
(63) Continuation-in-part of application No. 17/766,002, filed on Apr. 1, 2022.

(30) Foreign Application Priority Data
Oct. 4, 2019 (BR) 10 2019 020997 6

(51) Int. Cl. B42D 25/29; G09B 21/00; G06K 19/07

(52) U.S. Cl. CPC B42D 25/29; G09B 21/006; G06K 19/0723

(57) ABSTRACT

Smart banknotes incorporating permanent data transmission and reception elements to enable the storage of encrypted and unencrypted data that can be accessed at medium distances using electronic equipment, thereby enabling the definition/description of the banknote, the registration thereof, the central bank serial number and history, and other security data of interest, enabling security and control plans. The banknotes help people with visual impairments to identify banknotes and the value thereof, fostering greater social inclusion and independence when handling cash, and will be very useful for recognizing different types of banknotes, including in all countries that adopt the system. The banknotes may be used with everyday equipment on the market such as gadgets, and also drawers, counters, ATMs, and the like. Since they can provide audio and/or visual information, it is of greater use and efficiency in comparison to any existing product, and therefore has broad market applicability and social utility.

### CROSS-REFERENCE TO RELATED APPLICATIONS

This application is a continuation-in-part of U.S. patent application Ser. No. 17/766,002, filed Apr. 1, 2022, which is a 371 of PCT/BR2020/050395, filed Oct. 1, 2020, which claims priority to Brazilian Patent Application No. 10 2019 020997 6, filed Oct. 4, 2019, the entire contents of which are incorporated by reference herein.

### FIELD

The embodiments disclose to an intelligent monetary transactions product (banknotes) capable of self-identification by visual, audible and electronic means in a passive way, including data transmission and reception elements, for example transponders in the structure thereof.

### BACKGROUND

Conventional monetary systems leave much to be desired in terms of security, particularly with regard to counterfeiting and tracking. Furthermore, secure and traceable banknotes may still be considered ineffective and incipient in absolute terms, and represent a small percentage of attempts at global success in terms of cash. Additionally, conventional banknotes present other issues, such as, for example, the lack of banknotes that meet the needs of blind and visually impaired people and that meet Brazilian and international laws and requirements of accessibility, rights of people with disabilities and also technological development to meet the technological intelligence that has been produced worldwide with the implementation of IoT, AI, smart cities, and humanitarian programs.

Accordingly, an improved smart banknote system produced as cash, and developed with the addition of a data transmission and reception element (transponder), a resistant and first-rate high-level electronic data device is desired. Embodiments can include monetary banknotes with data transmission and reception elements (transponder), allowing such banknotes to become revolutionary in the safe cash market and also in the technological segment of the internet of things (IoT). Accordingly, the present embodiments are not only a monetary banknote, but a high-tech computerization product that can become part of an IT (Information Technology) system and even more complex systems such as Intelligence and Security.

### SUMMARY

Embodiments disclosed herein can allow storage of encrypted and unencrypted data that can be accessed at medium distances (for example, approximately up to 10 meters) by means of electronic equipment, thus allowing transmission of banknote characteristics such as the definition, description of the banknote, its registration, series in the Central Bank and its history, in addition to other safety data that may be specific to a particular country, as well as editing of data and/or addition of new data.

### DETAILED DESCRIPTION

Embodiments herein disclose banknotes including data transmission and reception elements (transponder), characterizing an intelligent system, with standards for the perception and guidance of visually impaired people and their own monetary security systems.

The present embodiments disclose a system including intelligent monetary banknotes that may be formed from paper, plastic, fabric or any synthetic composite material, and that include data transmission and reception elements (transponders), and furthermore possess exceptional physical and mechanical characteristics. The banknotes can present physical characteristics and design that are particular to a specific country, and can be variable in weight and dimensions. The data transmission and reception elements, transponders, may be arranged in a very compact, extremely thin and flexible configuration resulting in a composite element, which can include materials pertinent to the banknotes used in a particular country that. The banknotes may further include an adhesion promoter that can create an indissoluble bond between the banknote layers, the polymer chains, and the transmission elements.

The transponders may be microelements that include an identification element and a capture and reflection antenna; such elements may have a thickness of about 6 to 8 microns and may be disposed within the product from which banknotes are made, such as, for example, paper. The implanting of the transponders in the mass from which the paper results in the paper and the transponder becoming a single indissociable material. The layouts of the banknotes may be the same as the banknotes of each country; i.e., the layout of the banknote of the present embodiments may be the same as the banknotes in circulation. The transponders disposed within the banknote do not interfere externally with the design of the banknote.

Embodiments disclosed herein can present a favorable modification to quality, technology and aesthetics itself with regard to meeting the needs of a market, a social situation of integration, development of technology and communication, inclusion, as well as Brazilian and international accessibility legislation. As for the accessibility and the right of disabled people, they will also attend, without the use of “cats and dogs” because the solution so far found is the dimension of the notes and minimum reliefs that are lost with the use of the banknotes. Therefore, to meet a wider range of requests for the use of an accessible banknote, embodiments disclosed herein can include data transmission and reception elements (transponder), intelligent banknote, with a new configuration of compounds being important the great possibility of variables of interaction between user and object.

With the system properly installed, there will be no need for any external means for a user to identify which note or which notes are in his possession, in addition to the system also providing the sum of the number of notes he is checking. Such functionality may be performed through sound. For example, a banknote or a plurality of banknotes may communicate, via point-to-point communication, with a reading system. The reading system may be provided as a separate unit including an audio-emitting means, and capable of communicating with the banknote transponders, or may be provided, for example, as an app on a mobile communications device. In some embodiments, the separate unit of the reading system may also include a display means.

Via the reading system, the user may be provided information necessary for use of the banknote, for example, its value, and its data. The reading system may also provide an automatic count of a plurality of banknotes and inform the user of the total value. In this way. Other data of the banknote that may be provided to the user via the reading system can include all the necessary data established by each country, such as series, print, run, place of origin, name of the person responsible for its issue, and all other data that may be deemed necessary.

Embodiments disclosed herein can therefore allow users who are blind or not, to determine the descriptions of the banknotes. For example, the banknote can present an audible identification of itself to a user. Furthermore, anti-counterfeiting may also be enhanced, as it may be possible to identify whether a note is counterfeit or not by reading the note with the reading system. Furthermore, due to the complexity of execution in making the mass of paper with the transponder the transponder therein, counterfeiting may further be prevented. As each transponder includes unique data, a unique digital fingerprint for each banknote may be provided.

Embodiments disclosed herein can prevent the visual deficiencies in the identification of cash banknotes, thus allowing the identification of their value and genuineness by the visually impaired, thus enabling a greater inclusion of them in society and creating independence of the blind regarding the handling of cash. In the case of blind people, it is of great value to recognize various types of banknotes, including for all countries that adopt the system. The embodiments may be used through common market equipment, such as: cell phones, smartphones, tablets, watches, bracelets, lanyards, etc., as well as counters, ATMs, drawers, safes, furniture, and the like, for example, by including banknote reading systems in such common equipment, either natively or as external accessories. Depending on the type of application, it is possible to have banknote data presented audio and/or visual format.

The intelligent banknote system disclosed herein meet the needs of accessibility by making the banknotes accessible without reducing the security thereof, as well as increasing the features of quality, durability, wear resistance, information and tracking. Furthermore, the intelligent banknotes can enable high performance security and technological investigative solutions, where data transmission and reception elements (transponder) may be combined with other security and traceability systems necessary for each specific case.

For example, by way of the unique identification (fingerprint) by provided by the system which in each banknote, which will be used by central banks or the institute responsible for issuing and controlling the banknotes, it may be possible to identify the issuer of the banknote, whether the banknote is in the issuers database, when it was put into circulation and so forth. It may further be possible to know where the note circulated through the readings and checks made during its validity. It may further be possible to identify where when in which institutions it entered and left.

Tracking systems already belonging to the issuing and control entities can be added to the integrated systems of smart notes resulting in a more robust security without the need for modification in its essence but making it faster and more effective. Any note can be read and therefore identified anywhere at any time by point-to-point or remote means. A note may further be canceled through its serial number and registration remotely, for example only by the issuing body responsible for its control and circulation.

The intelligent banknotes can further facilitate automation of counting and transfer of cash in situations such as point of sale register, banks, bank vaults, and the such, while at the same time counting the identification of each banknote, therefore meeting the legal requirements and the needs of each segment that makes use of paper currency in its activities, thereby uniting functionality, technology and accessibility.

The embodiments disclosed herein can be integrated in any type of system of execution of existing banknotes, where it is necessary to exchange information between the being and the object, intended for sensory perception, circulation, identification and tracking of cash and service to people with visual impairment or not, aiming at the integration and description of the object, equipment, elements etc. for various purposes, such as alerting the user to values of the currency as well as situations of fraud or deception, in any internal and external environments. Furthermore, the banknotes can have the same shapes and dimensions, as regular banknotes already in use in each country. Therefore, without adding greater expenses with regard to standardization of dimensions that had already been applied in any currency system, the intelligent banknotes may further be interactive with the user and with other elements of artificial intelligence thus composing a system of the Internet of Things (IoT), and as is the banknotes are fully integrated and programmable, they can be used in various ways in accessibility, security and accounting, and so forth.

As this is the paper on which the banknote will be minted the result is independent of size and shape as these items remain, they do not need to be changed just change the usual paper for a technological paper the one used in our system. The system that through sound and/or writing point to point the note speaks to the user such information necessary for its use such as its value and its data in addition to allowing an automatic count immediately providing the sum reached this is done through a point-to-point system without the need for internet or any other means through a reading system the identified transponder and accesses an app that through the identification accesses the database (of the reader) and responds in audio and/or written to the reader's questioning. Now as a variant and expansion of use there is the possibility of using remote Apps thus constituting an IoT system initially for specific casual uses (curiosities history of illustrations history of the Mint history of the banknote family etc.) also in specific cases of security by the issuing and controlling institute.

The possibility of connecting to the internet enables access remotely as service providers, this ability generates a large number of opportunities in the technological, industrial and social sphere.

From then on, the banknotes will be able to interact with whoever is in the created environment. In this way, the conventional banknote cash system is transformed into a smart banknote cash system. The smart banknote system can further interact with “smart boxes” such as a smart teller system, a smart money security system and so on. As the basis of bank notes is a transponder system, the notes communicate with all AI data exchange systems in the case of smart boxes also with an AI system exchange information and data with the notes. In this way, the smart boxes acknowledge receipt of the note and its specifications immediately upon receipt and likewise when cash is output from the smart boxes the same acknowledges these subtractions. So, with the system of smart notes and smart boxes, one can know the value of the balance in cash. This provides security as the amount of cash in the box is known as well as all entries and exits with the respective times of movement. The same principle applies to the description of bank safes, bill dispensers, terminals etc. The intelligent system can allow the interaction of the note with the place where it is stored with the static readers installed therein, all cash movement may be passed to the database of the place of reading immediately. For example, a cash register drawer may automatically count each note that enters or leaves it. As a further example, a bank vault can count every banknote that circulates there, resulting in its entry and exit record.

Embodiments of the smart currency banknotes can provide a fully interactive environment including both users and equipment that will be able to interact with the banknotes and thus complement a sequence of IoT, Internet of Things.

Further embodiments disclose intelligent banknotes that can facilitate intelligent monetary transactions and that can provide self-identification by visual, audible and electronic means in a passive way, wherein the data transmission and reception elements (transponders) disposed within the intelligent banknotes allow the storage of encrypted and unencrypted data that can be accessed at medium distances of approximately up to 10 meters, through electronic equipment. Thereby, the definition, description of the banknote, its registration, series in the central bank and its history, in addition to other security data according to each country can be transmitted. The intelligent banknotes can further allow visually impaired users to know the descriptions of the banknotes, as the banknotes may be developed to mitigate visual deficiencies in the identification of regular cash notes, thereby allowing the identification of the value of the same by the visually impaired, and enabling a greater inclusion of the visually impaired in society and promoting their independence with respect to the handling of cash. The banknotes can be adapted for use with common market equipment, such as gadgets, smartphones, tablets, watches, bracelets, cords, etc., as well as counters, ATM, drawers, furniture, safes, and the like. Implementation may take place through programming and a specific project for each case as in the case of banks and supermarket checkouts with the installation of fixed readers.

The banknotes may further include information in audio and/or visual format. The banknotes may be formed from paper, plastic, fabric or any synthetic material. The banknotes can be variable in weight and dimensions so as to conform to the physical characteristics and design of each country. The transponders can be arranged within the banknote, providing a compact, thin and flexible configuration resulting in a composite element, consisting of materials pertinent to the banknotes of each country.

According to further exemplary embodiments, the banknote can include embedded therein a passive micro transponder (without load), configured for point-to-point identification. Such transponder does not carry any data, thereby increasing security, as no data related to the transponder can be changed. Such a configuration can ensure that, after the transponder is issued, cannot undergo any change in its identification. Furthermore, all data is part of a database, which can be controlled by the mint and/or the central bank of the country issuing of the banknote. All data pertinent to the intelligent banknote system is disposed outside the peer-to-peer system. The transponder therefore provides a unique system of access to a single piece of information in the banknote. In other words, the transponder can provide a “fingerprint” of the note, that is, a unique identification of the note. There is no data storage in the note or the transponder. The transponder carries only an identification component, which may be composed of alphanumeric codes that are generated during the creation of the intelligent banknote. In the intelligent banknote system the transponder does not carry data, only its identification composed of alphanumeric codes that are generated in its conception. The identification code in the transponder provides all relevant systems the necessary information for use and exchange of the banknote.

A banknote according to the embodiments disclosed herein becomes “intelligent” when it is registered in the central bank and/or mint of the relevant country. The data related to the note is stored in a system of the central bank and/or mint.

In addition to the immediate identification of the note, a banknote according to the embodiment disclosed herein can be made to communicate its value to the user, thus meeting the need of visually impaired users. Further embodiments enable a bearer of more than one note can know the sum of the values of these notes immediately.

What is claimed is:

1. An intelligent banknote system, comprising:
at least one intelligent banknote, the intelligent banknote being flexible and comprising a transponder, the intelligent banknote being sized and shape to conform to banknote standards of an issuing country;
a data storage database, the data storage database containing data pertaining to at least the country, denomination, registration, series, and transaction history of the intelligent banknote;
the banknote further comprising means for identification of the banknote by visually impaired individuals; and
at least one terminal adapted to communicate with the intelligent banknote at a distance of up to 10 meters;
wherein the transponder includes a unique identifier of the banknote; and
wherein the unique identifier of the banknote is registered in the data storage database and associated with the data pertaining to at least the country, denomination, registration, series, and transaction history of the intelligent banknote.

2. The intelligent banknote system of claim 1, wherein the at least one terminal is an ATM, a personal communications device, a watch, a wearable accessory, or a furniture item.

3. The intelligent banknote system of claim 1, further comprising IoT integration.

4. The intelligent banknote system of claim 1, wherein the means for identification of the banknote by visually impaired individuals is an audio emitting means.

5. The intelligent banknote system of claim 1, the intelligent banknote further comprising fraudulent transaction identifying means.

6. The intelligent banknote system of claim 1, wherein the data storage database is controlled by a central bank and/or a mint of an issuing country of the intelligent banknote.

7. The intelligent banknote system of claim 6, wherein the intelligent banknote is registered in the data storage database utilizing the unique identifier upon creation of the banknote.
